(19) United States
(12) Patent Application Publication
(10) Pub. No.: US 2021/0241140 A1
(43) Pub. Date: Aug. 5, 2021

(54) HYBRID METHODS AND SYSTEMS FOR FEATURE SELECTION

(71) Applicants: Thejas Gubbi SADASHIVA, Miami, FL (US); Sundararaj S. IYENGAR, Miami, FL (US)

(72) Inventors: Thejas Gubbi SADASHIVA, Miami, FL (US); Sundararaj S. IYENGAR, Miami, FL (US)

(73) Assignee: The Florida International University Board of Trustees, Miami, FL (US)

(21) Appl. No.: 16/782,730

(22) Filed: Feb. 5, 2020

(51) Int. Cl. G06N 5/04; G06N 20/00; G06F 16/28; G06F 16/215

(52) U.S. Cl. CPC G06N 5/04; G06F 16/215; G06F 16/285; G06N 20/00

(57) ABSTRACT

Methods and systems for feature selection (FS) in machine learning (ML) are provided. The filter and wrapper methods can be combined to provide a hybrid FS method and system. The data can be clustered using mini-batch K-means clustering and ranked using normalized mutual information (NMI). The wrapper method can include using either a feature inclusion process or a least-ranked feature exclusion process that eliminates least-ranked features one by one from the ranking list.

### BACKGROUND

Feature selection (FS) is a significant preprocessing procedure for classification in the area of supervised machine learning (ML). It is mostly applied when the attribute set is very large, as a large set of attributes often tends to misguide the classifier. One of the essential phases in classification is to determine the useful set of features for the classifier. In supervised as well as in unsupervised ML, the large volume of data is a significant problem and is becoming more prominent with the increase in data samples and the number of features in each sample. The main intention of reducing the dimension by keeping a minimum number of features is to decrease the computation time, obtain greater accuracy, and reduce overfitting.

Dimensionality reduction is divided into two categories: feature extraction (FE); and FS. In FE, the existing features are transformed into new features with lesser dimensionality, employing a linear or a nonlinear combination of features. The actual data is manipulated and hence not immune to distortion under transformation. In the FS process, a feature's subset is selected based on some criteria. Many of the attributes in the dataset may be utterly irrelevant to the class or redundant when considered along with other features. The accuracy of the induced classifier is decreased by the presence of irrelevant or redundant features. Identifying such features and removing them reduces the dimensionality, which in turn reduces the computation time and improves the accuracy.

FS has many applications in various fields like image processing, natural language processing, bioinformatics, data mining, and ML. The selection method is divided into two standard categories based on their working modules: classifier-independent “filter” technique; and classifier-dependent “wrapper” and “embedded” techniques. The filter technique, a classifier-independent process, performs the selection of the features based on statistical metrics such as distance, correlation, consistency measure, and mutual information (MI). It either ranks the features or provides a relevant subset of features associated with the class label. It improves the computational efficiency and scales down the data dimensionality by being entirely independent of the classifier. A drawback of this process is the lack of knowledge regarding the relationship between feature attributes and target class.

The classifier-dependent systems rely upon the classifier for the selection process. The wrapper method uses the outcome of the classifier to obtain the subset of features, making it biased to a classifier. Also, it is vulnerable to overfitting, mostly when the quantity of data is very small. The embedded method makes use of the classifier in the training phase and selects the optimal features like a learning procedure. When compared to the wrapper method, the embedded method is less vulnerable to overfitting and computation is much faster. These existing methods, including the filter technique, have drawbacks.

### BRIEF SUMMARY

Embodiments of the subject invention provide methods and systems for feature selection (FS) in machine learning (ML) (e.g., supervised or unsupervised ML). The filter and wrapper methods can be combined to provide a hybrid FS method and system having the advantages of both techniques. As with the filter method, the hybrid FS method can be fast and general, and as with the wrapper method, the hybrid FS method can be a learning algorithm that obtains the best set of features without the need for a user to input the feature number (unlike most established algorithms like recursive feature elimination (RFE)). The data can be clustered using, for example, mini-batch K-means clustering, though embodiments are not limited thereto. The data can be ranked using normalized mutual information (NMI), which is a measure to calculate the relevance and the redundancy between a candidate attribute and the class, though embodiments are not limited thereto. A greedy search method can be applied (e.g., by using random forest (RF)) to get the optimal set of features, though embodiments are not limited thereto. The hybrid FS method is flexible in terms of the learning algorithm that can be used.

In an embodiment, a system for performing FS in ML can comprise: a processor; and a machine-readable medium in operable communication with the processor and comprising instructions stored thereon that, when executed by the processor, perform the following steps: receiving a dataset; performing feature ranking on the dataset using a filter technique to obtain a ranking list of features; and performing feature selection on the ranking list using a wrapper technique. The filter technique can comprise K-means clustering, such as mini-batch K-means clustering. The filter technique can comprise clustering the data of the dataset and then using NMI as a metric for ranking to generate the ranking list of features. The wrapper technique can comprise removing redundant features, such as those that have a dependency on other features. The wrapper technique can comprise performing either: a feature inclusion process; or a least-ranked feature exclusion process that eliminates least-ranked features one by one from the ranking list. The feature inclusion process can comprise performing Algorithm 1 (detailed herein), and the least-ranked feature exclusion process can comprise performing Algorithm 2 (detailed herein).

In another embodiment, a method for performing FS in ML can comprise: receiving (e.g., by a processor) a dataset; performing (e.g., by the processor) feature ranking on the dataset using a filter technique to obtain a ranking list of features; and performing (e.g., by the processor) feature selection on the ranking list using a wrapper technique. The filter technique can comprise K-means clustering, such as mini-batch K-means clustering. The filter technique can comprise clustering the data of the dataset and then using NMI as a metric for ranking to generate the ranking list of features. The wrapper technique can comprise removing redundant features, such as those that have a dependency on other features. The wrapper technique can comprise performing either: a feature inclusion process; or a least-ranked feature exclusion process that eliminates least-ranked features one by one from the ranking list. The feature inclusion process can comprise performing Algorithm 1 (detailed herein), and the least-ranked feature exclusion process can comprise performing Algorithm 2 (detailed herein).

### BRIEF DESCRIPTION OF DRAWINGS

FIG. 1 is a plot of runtime (in seconds (s)) versus number of data (in millions (10⁶)) showing a runtime analysis of K-means and mini-batch K-means. For each section of number of data (1, 3, 5, 7, and 9), the left-hand bar is for K-means and the right-hand bar is for mini-batch K-means. FIG. 1 is from Ml: Mini batch k-means clustering algorithm, May 2019.

FIG. 2 is a plot of ranking values versus feature name, showing feature ranking for the Sonar Dataset (a dataset from Frank, UCI machine learning repository, http://archive.ics.uci.edu/ml, 2010).

FIG. 3 is a plot of accuracy percentage versus number of features eliminated, showing a change in accuracy in a mini-batch K-means normalized mutual information least ranked feature elimination (KNFE) method, using the Sonar Dataset.

FIG. 4 is a flow chart of a feature ranking process, according to an embodiment of the subject invention.

FIG. 5 is a flow chart of a K-means normalized mutual information feature inclusion (KNFI) method, according to an embodiment of the subject invention (labeled as “KNMI Method” in the figure).

FIG. 6 is a flow chart of a KNFE method, according to an embodiment of the subject invention.

### DETAILED DESCRIPTION

Embodiments of the subject invention provide methods and systems for feature selection (FS) in machine learning (ML) (e.g., supervised or unsupervised ML). The filter and wrapper methods can be combined to provide a hybrid FS method and system having the advantages of both techniques. As with the filter method, the hybrid FS method can be fast and general, and as with the wrapper method, the hybrid FS method can be a learning algorithm that obtains the best set of features without the need for a user to input the feature number (unlike most established algorithms like recursive feature elimination (RFE)). The data can be clustered using, for example, mini-batch K-means clustering, though embodiments are not limited thereto. The data can be ranked using normalized mutual information (NMI), which is a measure to calculate the relevance and the redundancy between a candidate attribute and the class, though embodiments are not limited thereto. A greedy search method can be applied (e.g., by using random forest (RF)) to get the optimal set of features, though embodiments are not limited thereto. The hybrid FS method is flexible in terms of the learning algorithm that can be used.

Extensive research has been performed to increase the efficacy of the predictor in FS by finding an optimal set of features. The feature subset should be such that it enhances the classification accuracy by the removal of redundant features. Embodiments of the subject invention provide a new feature selection mechanism, which is an amalgamation of the filter technique and the wrapper technique, by taking into consideration the benefits of both the filter and wrapper methods to arrive at a hybrid FS model or method. The hybrid model is based on a two-phase process where the features are ranked and then the best subset of features is chosen based on the ranking. As discussed in the examples, the model has been validated with various datasets, using multiple evaluation metrics, and with comparison to existing methods and algorithms. The hybrid FS model outperforms the existing methods and provides excellent results.

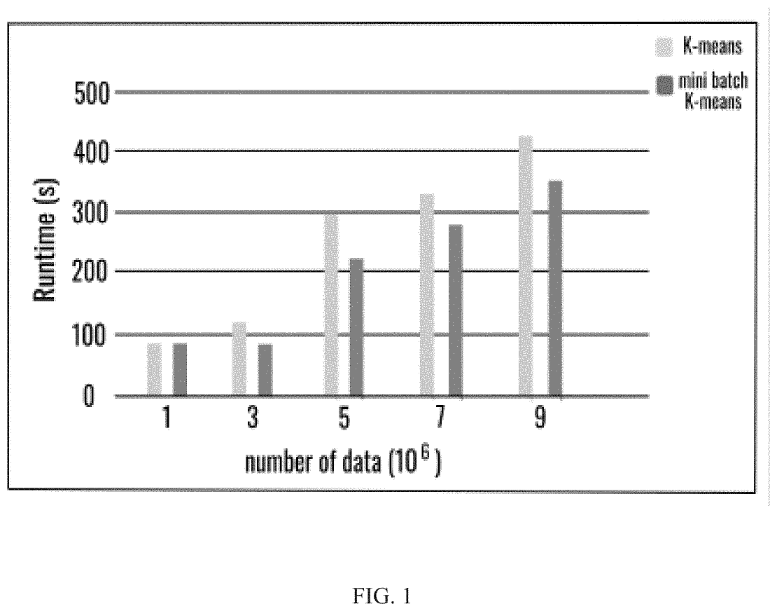

K-means is a popular clustering algorithm, and with the increase in dataset size, the computation time increases as all the data needs to be present in the main memory. Because of this, embodiments of the subject invention can use mini-batch K-means for large datasets. A fixed size of small random batches of data can be applied for easy storage in the memory. In each iteration, the cluster is updated taking new random samples from the dataset. For a given dataset D=x₁, x₂, x₃, . . . , xₚ, xᵢ ∈ R^{m,n}, xᵢ represents the records in an n-dimensional real vector. The number of records in dataset D is “m”. A set S of cluster center s ∈ R^{m,n} is obtained to decrease over the dataset D of records s ∈ R^{m,n} as shown in the following function.

$$Min {\sum }_{x ∈ T} {‖ f ( S , x ) - x ‖}^{2} \qquad ( 1.1 )$$

where f(S,x) yields the nearest cluster center s ∈ S to record x. If K is the number of clusters, it is given by k=|S|. K records can be randomly selected by using Kmeans++ to initialize the centers, and the cluster centers S can be set to be equal to the values of these. In this case, the number of clusters can be considered as equal to the number of class. When the amount of data is very large, the convergence rate of the original K-means significantly drops, so the improved K-means—mini-batch K-means can be used (see also, Sculley, Web-scale k-means clustering, In Proceedings of the 19th international conference on World wide web, pages 1177-1178. ACM, 2010; which is hereby incorporated herein by reference in its entirety). FIG. 1 demonstrates the improved runtime of mini-batch K-means compared to original K-means.

Normalized mutual information (NMI) is a method for measuring the criteria of cluster quality, which is information-theoretic interpretation. This measure calculates the cluster quality with cluster number. Mathematically :

$$NMI ( Ω , S ) = \frac{MI ( Ω ; S )}{[ G ( Ω ) + G ( S ) ) ] / 2} \qquad ( 1.2 )$$

where Ω is the set of clusters and S is the set of classes. Here MI is given by the formula:

$$MI ( Ω ; S ) = {\sum }_{k} {\sum }_{j} P ( {d}_{k} ⋂ {s}_{j} ) log \frac{P ( {d}_{k} ⋂ {s}_{j} )}{P ( {d}_{k} ) P ( {s}_{j} )} \qquad ( 1.3 )$$

where P(dₖ)=probability of document in cluster dₖ, P(sⱼ)=probability of document in cluster sⱼ, and P(dₖ∩sⱼ)=probability of document being in the convergence of dₖ and sⱼ.

NMI increases the knowledge of the class by evaluating the amount of information obtained from the clusters. The value is 0 when the clustering is random concerning the class and gives no knowledge about the class. MI reaches maximum value if it perfectly recreates the classes. G is the entropy, and is represented mathematically as follows:

$$G ( Ω ) = - {\sum }_{k} ( {d}_{k} ) log P ( {d}_{k} ) \qquad ( 1.4 )$$

This gives the entropy of cluster levels. The normalization in Equation 1.2 by the denominator solves the problem of purity. It also formalizes that fewer clusters are better because the entropy usually increases with the increase in cluster number. The value of NMI is always between 0 and 1.

Embodiments of the subject invention provide a hybrid filter-wrapper approach for FS. There are two objective functions in the hybrid approach, including the feature ranking function based on the filter approach and the selection of optimal features based upon the rankings. This optimal selection is a wrapper-based method that depends upon the outcome of the learning algorithm. This approach is independent of any number of class labels and is suitable to use with any classifier. Though the examples use RF as the classifier, this is for exemplary purposes only and any classifier can be used. The hybrid approach can have two phases: feature ranking; and FS.

### Feature Ranking

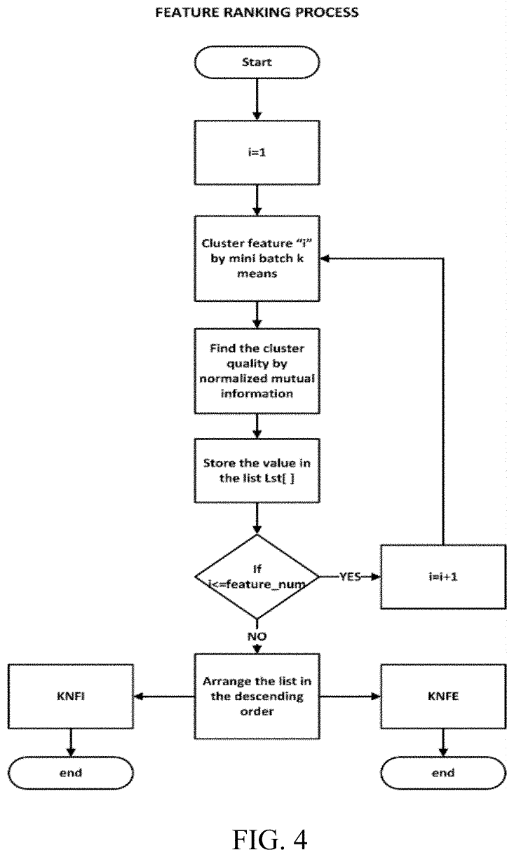

In the first phase, the main idea is to separately cluster the features one by one based upon the total classes in the dataset. The objective is to have a selection algorithm that takes less computation time in comparison to existing algorithms. Because datasets are typically very large currently, mini-batch K-means can be used. Mini-batch K-means takes into account a batch of data and performs clustering, and the computation time is much less than the normal (or original) K-means clustering. The cluster's quality is the metric to find the relation of that feature with the class. As the cluster quality increases, the feature tends to be more relevant and is considered to be more important. The use of NMI gives a cluster score from 0 to 1. A high ranking score indicates better classification using the candidate feature. The cluster score for all the features is evaluated separately. Comparing the score of each feature, the ranking list is obtained and is based upon the individual relationship between the candidate attribute and the class label. FIG. 4 shows a flowchart of the feature ranking process.

### Feature Selection

In the FS problem, a feature variable may have a dependency on other variables. Dependent features tend to produce imbalanced results when acted upon together and hence, such a feature variable would be considered a redundant feature. The redundant feature tends to deteriorate the classification process, and these are removed in the hybrid process of embodiments of the subject invention. The ranking obtained from the first phase can be considered as the base for the selection of features. This can be considered to have a linear approach of selecting the features to get the optimal features in minimum time. When the feature size in the dataset increases, comparison with all the possible subsets is an impractical approach and seems to be computationally very expensive. Two approaches can be used for the selection of features: feature inclusion; and/or least ranked feature exclusion

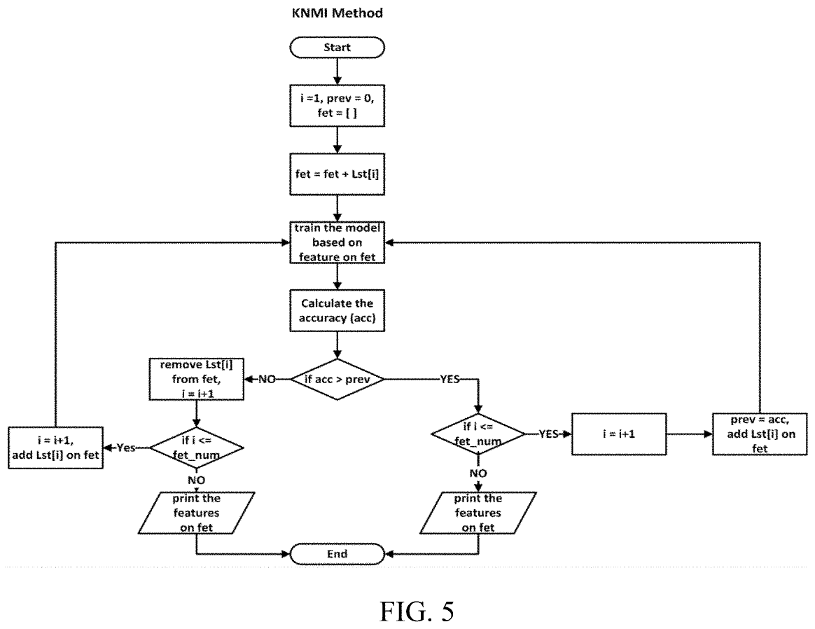

Feature Inclusion: This is almost a linear selection approach where the ranked features from phase one are added one by one into the subset. If the addition of the features enhances the classification accuracy, the feature is considered, and if not the feature is discarded. Here, the highest ranked feature is initially included in the list as shown in step one of Algorithm 1. The next ranked feature is added and its performance is obtained. If the performance increases, the feature is added into the list and if not the feature is discarded. The feature is removed if it does not perform well with the selected subset, considering that it is redundant as it degrades the classification model. This process loops for all the features, as shown in Algorithm 1. This process can be referred to as mini-batch K-means normalized mutual information feature inclusion (KNFI). FIG. 5 shows a flow chart of the KNFI process.

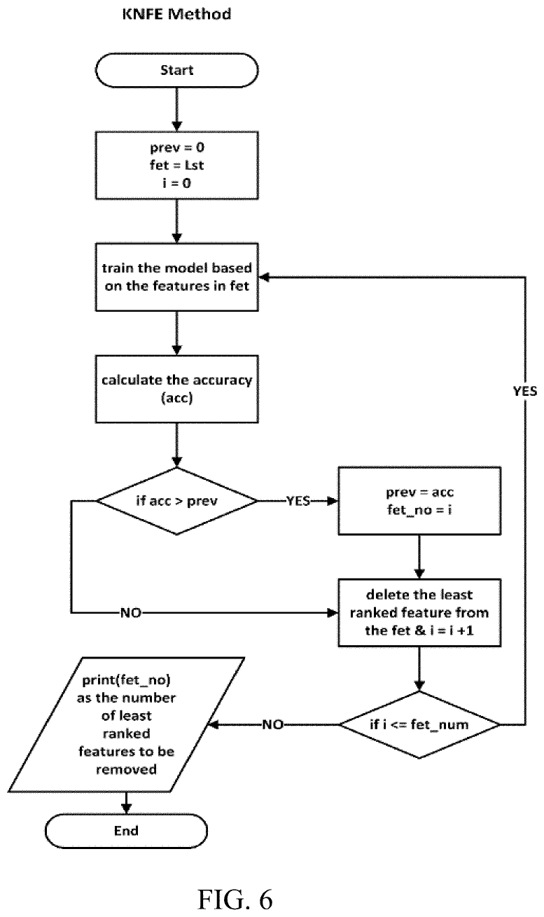

Least Ranked Feature Exclusion: This is a linear elimination approach where the least-ranked features are eliminated one by one from the entire set of features. Initially, the list includes all the features and the classification accuracy is calculated for the entire list. Then, in every loop, one least-ranked feature is removed from the list. This process is carried out until the list becomes empty. The highest performance among all the iterations is considered as the outcome of the approach, as shown in Algorithm 2. This process can be referred to as mini-batch K-means normalized mutual information least ranked feature exclusion (KNFE). FIG. 6 shows a flowchart of the KNFE process.

Embodiments of the subject invention provide hybrid methods that take into consideration the advantages of both filter and wrapper methods with no constraint for a user to input the number of features required. In one embodiment, the NMI can be used as a metric to rank the features after clustering by mini-batch K-means. Once the ranked features are obtained, the features can be selected by a particular method (e.g., by a feature inclusion method (KNFI) or a feature exclusion method (KNFE)). In the feature removal method, the least important features can be removed to get the best performance accuracy.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

Algorithm 1 Ranking based Feature Inclusion for optimal feature subset(KNFI)

Input: Set of ranked features S = {f₀, f₁, f₂, . . . fₘ}, where m = total number

of features, obtained from the feature ranking phase, f₀ is the highest ranked
feature and fₘ is the least ranked feature.

Output: prints the selected set of features

| | |
|---|---|
| | Initialisation : |
| 1: | Lst = S[0] prev=0 |
| | LOOP Process |
| 2: | for k = 0 to m−1 do |

| | |
|---|---|
| 3: | x_tst = x_tst [ Lst ] |
| 4: | x_tr =x_tr [ Lst ] |
| 5: | train the model based on any classifier and store the accuracy on acc |
| 6: | if acc > prev then |

| | |
|---|---|
| 7: | if (k ≠ m − 1) then |

| | |
|---|---|
| 8: | Add S[ k + 1 ] into the Lst |
| 9: | prev=acc |

| | |
|---|---|
| 10: | else |

| | |
|---|---|
| 11: | Print Lst |

| | |
|---|---|
| 12: | end if |

| | |
|---|---|
| 13: | else |

| | |
|---|---|
| 14: | Remove S [ k ] object from the Lst |
| 15: | if (k ≠ m − 1) then |

| | |
|---|---|
| 16: | Add S[ k + 1 ] to the Lst |

| | |
|---|---|
| 17: | else |

| | |
|---|---|
| 18: | Print Lst |

| | |
|---|---|
| 19: | end if |

| | |
|---|---|
| 20: | end if |

| | |
|---|---|
| 21: | end for |
| 22: | return Lst |

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

Algorithm 2 Ranking based Feature elimination(KNFE)

Input: Set of ranked features S = {f₀, f₁, f₂, . . . fₘ}, where m = total number of

features, f₀ is the least ranked feature and fₘ is the highest ranked feature.

Output: prints the result for every eliminated feature from the feature list

| | |
|---|---|
| | Initialization : |
| 1: | Lst = S prev=0 |
| | LOOP Process |
| 2: | for k = 0 to m−1 do |

| | |
|---|---|
| 3: | x_tst = x_tst [ Lst ] |
| 4: | x_tr =x_tr [ Lst ] |
| 5: | //train the model based on any classifier and store the accuracy on acc |
| 6: | //print the result along with the evaluation metrics |
| 7: | if acc > prev then |

| | |
|---|---|
| 8: | prev=acc // to store the greatest accuracy |
| 9: | fet=i // to store the no. of feature eliminated |

| | |
|---|---|
| 10: | end if |
| 11: | delete Lst[0] //deleting the least ranked feature |

| | |
|---|---|
| 12: | end for |
| 13: | return |

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to the invention.

### EXAMPLE 1

Several experiments were run to test they hybrid FS methods and systems of embodiments of the subject invention. All experiments were performed at Florida International University in Python Language using the python libraries. An Intel i7 4 core CPU with 16 GB RAM was used, and for large datasets, the Flounder Server (AMD Opteron Processor 6380 with 64 cores and 504 GB RAM) was used.

Abbreviations referring to related works (e.g., for comparison and for obtaining datasets used for testing) are used throughout the Example section. The abbreviations refer to related works as follows.
“uns15”—unsw.adfa.edu.au, Unsw-nb15 dataset, 2015.
“TKC+19”—Thejas et al., Deep learning-based model to fight against ad click fraud, In 2019 ACM Southeast Conference (ACMSE 2019), ACM '19, New York, N.Y., USA, 2019.
“Kag14”—Kaggle.com. Display advertising challenge, 2014.
“Kag15”—Kaggle.com. Click-through rate prediction, 2015.
“Fra10”—Frank, UCI machine learning repository, http://archive.ics.uci.edu/ml, 2010.
“D.18”—Anh D. sonar data set, February 2018.
“FD19”—Faker et al., Intrusion detection using big data and deep learning techniques, In Proceedings of the 2019 ACM Southeast Conference, pages 86-93, ACM, 2019.
“AZAA17”—Al-Zewairi et al., Experimental evaluation of a multi-layer feed-forward artificial neural network classifier for network intrusion detection system, 2017 International Conference on New Trends in Computing Sciences (ICTCS), 2017.
“PT17”—Primartha et al., Anomaly detection using random forest: A performance revisited. 2017 International Conference on Data and Software Engineering (ICoDSE), 2017.
“MS17”—Moustafa et al., A hybrid feature selection for network intrusion detection systems: Central points. arXiv preprint arXiv:1707.05505, 2017.
“BEI17”—Belouch et al., A two-stage classifier approach using reptree algorithm for network intrusion detection, International Journal of Advanced Computer Science and Applications, 8(6), 2017.
“VA19”—Venkatesh et al., A hybrid feature selection approach for handling a high-dimensional data. In Innovations in Computer Science and Engineering, pages 365-373, Springer, 2019.
“XYW18”—Xue et al., A novel ensemble-based wrapper method for feature selection using extreme learning machine and genetic algorithm, Knowledge and Information Systems, 57(2):389-412, 2018.
“GFD16”—Ghaemi et al., Feature selection using forest optimization algorithm, Pattern Recognition, 60:121-129, 2016.
“ETPZ09”—Estevez et al., Normalized mutual information feature selection, IEEE Transactions on Neural Networks, 20(2):189-201, 2009.
“Bat94”—Battiti, Using mutual information for selecting features in supervised neural net learning. IEEE Transactions on neural networks, 5(4):537-550, 1994.
“KC02”—Kwak et al., Input feature selection for classification problems, IEEE transactions on neural networks, 13(1):143-159, 2002.
“CH05”—Chow et al., Estimating optimal feature subsets using efficient estimation of high-dimensional mutual information, Trans. Neur. Netw., 16(1):213-224, January 2005.

Nine datasets from the ML Repository of UCI [Fra10] were considered—three-click fraud datasets, one Intrusion Detection dataset, and the Sonar dataset. Tests were performed upon two versions of the TalkingData dataset. The information of these datasets is given in Tables 1.1 and 1.2. Fifteen datasets were selected having different number of features, instances, and classes. Also, both binary and multiclass datasets were used and are shown in Table 1.1 and Table 1.2, respectively.

TABLE 1.1
Binary Datasets used in experiment

| Dataset | Features | Instances |
|---|---|---|
| UNSW_NB15[uns15] | 47 | 2,540,047 |
| TalkingData(version 1)[TKC⁺19] | 9 | 1,000,000 |
| TalkingData(version 2)[TKC⁺19] | 9 | 913,692 |
| Criteo[Kag14] | 39 | 756,554 |
| Avazu[Kag15] | 16 | 1,000,000 |
| Ionosphere | 34 | 351 |
| Breast_Cancer[Fra10] | 10 | 699 |
| Spambase[Fra10] | 57 | 4,601 |
| Sonar[D.18] | 60 | 208 |

TABLE 1.2
MultiClass Datasets used in experiment

| Dataset | Features | # Classes | Instances |
|---|---|---|---|
| UNSW_NB15[uns15] | 47 | 9 | 2,540,047 |
| Lung_Cancer[Fra10] | 56 | 3 | 32 |
| Lymphographic[Fra10] | 18 | 4 | 148 |
| Iris[Fra10] | 4 | 3 | 150 |
| Heart Disease [Fra10] | 13 | 5 | 303 |
| Abalone [Fra10] | 8 | 28 | 4,177 |

The UNSW NB15 dataset [uns15] is an intrusion detection dataset that takes into consideration the instances of both the normal activities and the attack activities. To avoid overfitting due to a large number of normal activities, the normal activity instances were removed. Initially, the data was in four different CSV files. All the CSV files were merged into a single dataset and the experiments were performed. The socket information (i.e., source IP address, source port number, destination IP address and destination port number) were removed such that model becomes independent of them. The white spaces present in some of the multiclass labels were removed. All the categorical values were converted to the numerical values as the classifier can only learn numerical values. The different ranges of numerical data in the features become a challenge for the classifier to train the model [FD19]. To compensate this, normalization was performed on the entire data.

### TalkingData Dataset

TalkingData dataset is an AdTracking Fraud Dataset [Kag18] that has records of 200 million clicks over four days. It has features like app ID, OS, IP address, click time, device type, channel, attributed time, and target label as is attributed. In the preprocessing stage, the attributed time was dropped, and click time was separated into separate columns (i.e., day, hour, minute, and second). Two variants of the above mentioned dataset were used. In the first version, one million rows of data were considered in which the ratio of classes match the ratio at 200 million rows (Talkingdata Version 1). For the second variant, 913692 data samples were used, where the rows were equally categorized into two classes (Talkingdata Version 2) [TKC+19].

The Avazu dataset is a Click fraud dataset including clicks recorded over ten days and having features like ID, click (Target Label), device ID, device IP, an hour of click, and so on. The preprocessing (e.g., separation of the “hour of click” column into separate columns) was performed, and one million rows of data were considered in which the ratio of classes match the ratio at 200 million rows to reduce the data size.

Criteo dataset is a Click fraud dataset that includes 40 features. To clean the data, instances with “NaN” values were removed.

In the Ionosphere dataset provided UCI repository, the class labels (e.g., “good”, “bad”) were converted into numerical values.

In the Breast Cancer, Lung Cancer, and Heart Disease datasets, there were some missing values represented by a question mark (“?”). The instances containing “?” were removed as a cleaning process.

The Lymphography Dataset, and Iris Dataset were clean, and no preprocessing step had to be applied. However, resampling was performed as the instances with the same classes were together in the actual dataset.

In the Abalone dataset, the first feature included categorical string values that were converted into numerical values.

The Spambase dataset and Sonar dataset were considered to compare the hybrid model of embodiments of the subject invention with other related art approaches. The Spambase dataset is taken from the UCI repository [Fra10], and the Sonar dataset is taken from the Kaggle dataset. The datasets were clean with no NaN values, and no preprocessing was needed. The entire data was normalized by using MinMaxScalar function for all the datasets.

Random forest (RF) was used as a base classifier. RF is a prevalent supervised ML technique that is flexible and very easy to use. As the name implies, RF has a large number of individual decision trees, and each decision tree acts as an individual classifier. A class prediction is obtained from each tree in the RF, and the class that gets the most votes becomes the model prediction of RF. With the increase in the number of trees, the classifier has a greater ability to resist noise and obtain greater accuracy. The RF, being a simple classifier built on decision trees, can easily adapt to large changes in the data size, having the benefit of scalability.

The accuracy of the algorithm was evaluated by certain standard metrics. For binary classification, metrics considered included the standard metric, area under curve (AUC), and the F1 score, which is computed based upon the Precision and Recall score. For the multiclass dataset, metrics considered included the F1 Score as the evaluation criteria. The F1 Score can also be obtained from the confusion matrix. This metric can only be used for the test data whose true values are already known such that a confusion matrix can be obtained.

The following information can be obtained from the confusion matrix:

True Positive (TrPos): model correctly predicting positive cases as positive.

False Positive (FlPos): model incorrectly predicting negative cases as positive.

False Negative (FlNeg): model incorrectly predicting positive cases as negative.

True Negative (TrNeg): model correctly predicting negative cases as negative.

Precision score (Pr): It measures accuracy based upon correctly predicted cases.

$$Pr = \frac{TrPos}{TrPos + FlPos} \qquad ( 1.5 )$$

Recall score (RC): It is the TrPos rate to predict the frequency of predicting positive.

$$RC = \frac{TrPos}{TrPos + FlNeg} \qquad ( 1.6 )$$

F1 Score (F1): F1 is the weighted average of recall and precision of each class.

$$F 1 = 2 ( \frac{Pr * RC}{Pr + RC} ) \qquad ( 1.7 )$$

ROC-AUC curve is a standard metric to measure the performance of the classification model. The probability curve between the true positive rates against false positive rates is referred to as ROC, and AUC represents the degree of separability. The higher the AUC, the more the efficient the model.

To empirically test the advantages and disadvantages of the hybrid method of embodiments of the subject invention, several experiments were performed on real-world datasets with four different approaches, which were as follows.

Approach 1. This approach considered all the features present in the dataset for classification and calculation of its accuracy, using AUC (for binary datasets), precision, recall, and F1 score. This approach was represented as “All Features (AF)”.

Approach 2. KNFI, as used in embodiments of the subject invention, where classification is performed based on the ranked features and its evaluation metrics are determined. Without the need for a user to specify the number of optimal features, this approach automatically calculates it. This number has been considered as the base number for performing recursive feature elimination (RFE), where the required number of optimal features must be explicitly provided.

Approach 3. Using RFE, a standard process, provided by Scikit learn (Pedregosa et al., Scikit-learn: Machine learning in python. Journal of machine learning research, 12(October):2825-2830, 2011), selects features by recursively considering the small set of features. The user explicitly has to give the desired subset number (k), and then it returns the best accuracy from the best subset with k features. In this experiment, the value of K was considered, referring to the KNFI approach.

Approach 4. KNFE, as used in embodiments of the subject invention, where the least ranked features were removed one after another, performing the classification and calculating its evaluation metrics. The best accuracy obtained after removing k features is considered as the comparing value with other methods.

A comparative analysis was performed for the results obtained from the four approaches in terms of various evaluation metrics, as discussed above. The approaches used by embodiments of the subject invention took less computation time compared to the existing methods, and in many datasets, they produced better results.

### Binary Datasets

In the UNSW NB15 dataset, both the KNFI and KNFE methods improvised the learning algorithm to obtain greater accuracy, AUC, and F 1 score, as shown in Table 1.3. KNFI selected 17 features and stood superior in terms of all the evaluation metrics. Also, the evaluation metrics greatly increased in the Ionosphere dataset, as shown in Table 1.4, for the six selected features among the 34 features. Most of the redundant features were removed, giving better results.

A slight increase in accuracy was observed for both the KNFI and KNFE approaches for the Avazu dataset, as shown in Table 1.5. However, the AUC was slightly decreased for both of these methods. The decrease in AUC could be due to the presence of imbalanced data. The F1 score is a much better metric of measurement, and the F1 score remained constant with an increase in accuracy, giving a better-trained model with the selected features. This is reflected in Table 1.5. Also, in the TalkingData dataset (version 2), the accuracy increased slightly for KNFI, though for KNFE it showed zero elimination of features for the best classification accuracy meaning all the features are independent and contributing for the classification model.

TABLE 1.3
Experimental results of UNSW_NB15 Binary datasets

| Method | Ftr | Acc | AUC | F1 |
|---|---|---|---|---|
| AF | 43 | 99.93 | 99.46 | 99.93 |
| KNFI | 17 | 99.963 | 99.614 | 99.96 |
| RFE | 17 | 99.960 | 99.612 | 99.96 |
| KNFE | −6 | 99.944 | 99.96 | 99.94 |

TABLE 1.4
Experimental results of Ionosphere datasets

| Method | Ftr | Acc | AUC | F1 |
|---|---|---|---|---|
| AF | 34 | 92.96 | 90.91 | 92.84 |
| KNFI | 6 | 97.18 | 95.23 | 97.14 |
| RFE | 6 | 91.54 | 7.92 | 91.55 |
| KNFE | −7 | 95.77 | 94.238 | 95.74 |

TABLE 1.5
Experimental results of Avazu Dataset

| Method | Ftr. | Acc | AUC | F1 |
|---|---|---|---|---|
| AF | 25 | 83.029 | 54.235 | 77.89 |
| KNFI | 7 | 83.4375 | 53.283 | 77.89 |
| RFE | 7 | 83.075 | 53.013 | 77.63 |
| KNFE | −17 | 83.381 | 52.456 | 77.36 |

TABLE 1.6
Experimental results of Talking Dataset Version 2

| Method | Ftr. | Acc | AUC | F1 |
|---|---|---|---|---|
| AF | 9 | 99.9179 | 99.9179 | 99.92 |
| KNFI | 4 | 99.919 | 99.919 | 99.92 |
| RFE | 4 | 99.919 | 99.919 | 99.92 |
| KNFE | 0 | 99.9179 | 99.917 | 99.92 |

TABLE 1.7
Experimental results of Spambase Dataset

| Method | Ftr. | Acc | AUC | F1 |
|---|---|---|---|---|
| AF | 57 | 98.04 | 97.69 | 98.04 |
| KNFI | 15 | 97.82 | 97.52 | 97.82 |
| RFE | 15 | 97.285 | 96.69 | 97.27 |
| KNFE | −3 | 98.58 | 98.301 | 98.93 |

TABLE 1.8
Experimental results of Sonar Dataset

| Method | Ftr. | Acc | AUC | F1 |
|---|---|---|---|---|
| AF | 60 | 92.86 | 93.05 | 92.88 |
| KNFI | 3 | 95.24 | 95.138 | 95.24 |
| RFE | 3 | 88.09 | 88.88 | 88.16 |
| KNFE | −9 | 97.62 | 97.91 | 97.63 |

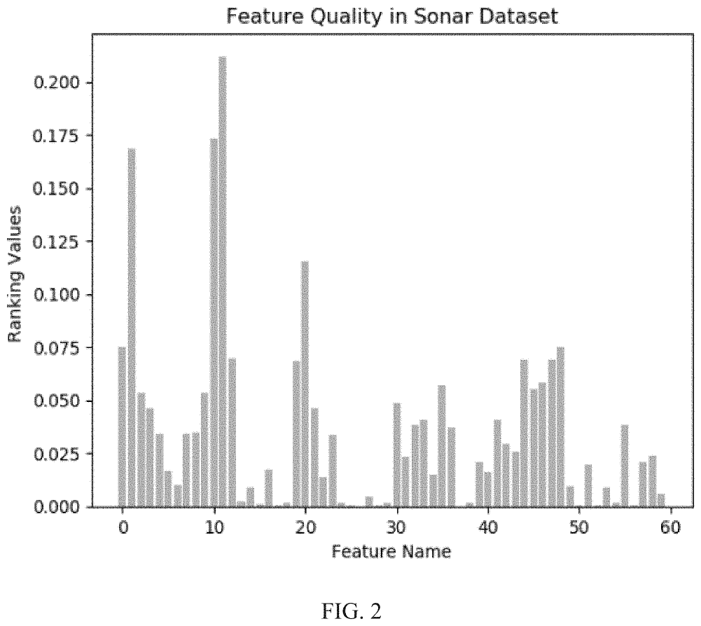

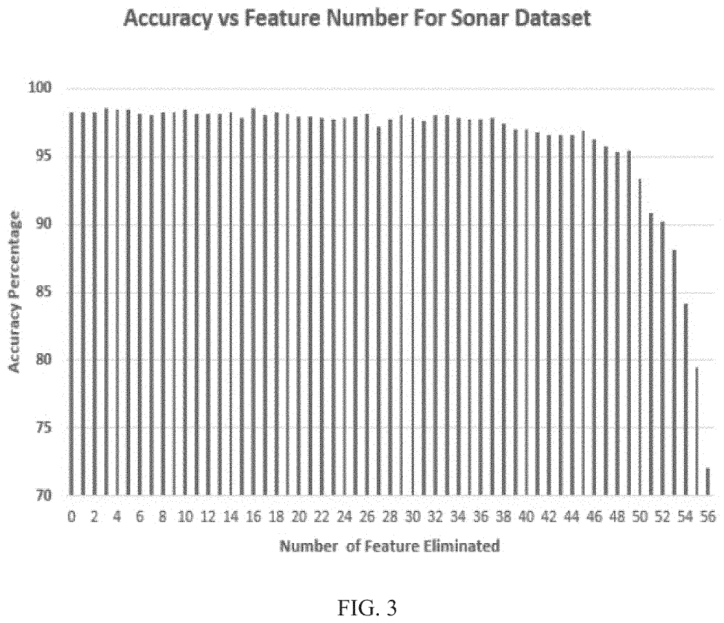

In the Spambase dataset, the KNFE approach enhanced the classification accuracy along with all the evaluation metrics by removing three redundant features. With the KNFI approach, the accuracy slightly decreased, taking least prediction time and performed well in comparison to RFE, as shown in Table 1.7. Also, in the Sonar dataset, the KNFE method outperformed all other approaches by removing nine redundant features. The KNFI approach also gave better results compared to the AF and RFE methods, as shown in Table 1.8. The relevance of the features in Sonar Dataset is shown in FIG. 2. Some features tend to have very high importance in accordance to the class label, and some features tend to have no importance or very low importance in accordance to the class label. The ranking of the features was obtained and then KNFI and KNFE were performed. Referring to FIG. 3, the change in the accuracy as the least ranked features are eliminated one at a time is shown. There is a drastic decrease in accuracy as a large number of features is eliminated. For a particular number of features eliminated, the highest accuracy was observed.

In the TalkingData (Version 1), Criteo, and Breast Cancer datasets shown in Tables 1.9, 1.10, and 1.11 respectively, the performance appeared to drop when performing the KNFI process. Though, KNFE gave either better results or the same results. This case appears when all the features tend to contribute to fitting the model. In such a scenario, either few features are removed or zero features are removed as in case the of TalkingData dataset (Table 1.9). The difference in prediction for AF contribution and zero feature elimination in KNFE is due to the change in the pattern of features provided during the training of data. The performance decreased in the KNFI model. Whenever proper information is not extracted from the FS process, the classification accuracy may be negatively affected, and the correlation of the features also affects the FS process. Further, when the sample size is large, the classifier predicts values well with the entire attributes, and some datasets tend to perform well with other classifiers.

TABLE 1.9
Experimental results of Talking dataset Version 1

| Method | Ftr. | Acc | AUC | F1 |
|---|---|---|---|---|
| AF | 8 | 95.127 | 91.672 | 95.08 |
| KNFI | 6 | 94.252 | 90.434 | 94.14 |
| RFE | 6 | 94.784 | 91.059 | 94.67 |
| KNFE | 0 | 95.20 | 91.72 | 95.11 |

TABLE 1.10
Experimental results of Criteo Dataset

| Method | Ftr. | Acc | AUC | F1 |
|---|---|---|---|---|
| AF | 39 | 73.545 | 62.386 | 70.29 |
| KNFI | 3 | 70.205 | 57.725 | 65.85 |
| RFE | 3 | 70.268 | 55.902 | 63.85 |
| KNFE | −5 | 73.545 | 62.45 | 70.33 |

TABLE 1.11
Experimental results of Breast Cancer Dataset

| Method | Ftr. | Acc | AUC | F1 |
|---|---|---|---|---|
| AF | 10 | 98.540 | 98.113 | 98.53 |
| KNFI | 4 | 97.810 | 97.517 | 97.81 |
| RFE | 4 | 94.890 | 93.744 | 94.84 |
| KNFE | −3 | 98.540 | 98.113 | 98.53 |

TABLE 1.12
Experimental results of UNSW_NB15 Dataset

| Method | Ftr. | Acc | F1 |
|---|---|---|---|
| AF | 43 | 89.326 | 88.87 |
| KNFI | 16 | 90.107 | 88.88 |
| RFE | 16 | 89.356 | 89.02 |
| KNFE | −18 | 89.591 | 89.02 |

### Multiclass Datasets

In most of the MultiClass datasets, the positive impact of the KNFI and KNFE techniques can be observed. In the UNSW NB15 dataset (Table 1.12), the accuracy increased by 0.781 percent along with the increase in F1 score. The model selected 16 out of 43 features to get the most efficient results. The KNFI method enhanced the accuracy and outperformed all other methods giving good results.

For the Lung cancer dataset (Table 1.13), both the KNFI and KNFE methods doubled the accuracy as well as the F1 score and took the least prediction time. Similarly, for the Lymphographic dataset (Table 1.14), the KNFE method gave better results than all other methods.

TABLE 1.13
Experimental results of Lung_Cancer dataset Dataset

| Method | Ftr. | Acc | F1 |
|---|---|---|---|
| AF | 56 | 33.333 | 37.78 |
| KNFI | 3 | 66.666 | 68.25 |
| RFE | 3 | 50.00 | 52.78 |
| KNFE | −14 | 66.666 | 68.25 |

TABLE 1.14
Experimental results of Lymphography dataset Dataset

| Method | Ftr. | Acc | F1 |
|---|---|---|---|
| AF | 18 | 86.66 | 85.19 |
| KNFI | 2 | 90.00 | 89.78 |
| RFE | 2 | 76.66 | 80.00 |
| KNFE | −2 | 86.66 | 75.17 |

TABLE 1.15
Experimental results of Iris dataset Dataset

| Method | Ftr. | Acc | F1 |
|---|---|---|---|
| AF | 4 | 96.666 | 96.67 |
| KNFI | 2 | 99.9999 | 99.99 |
| RFE | 2 | 99.999 | 99.999 |
| KNFE | −4 | 99.999 | 99.999 |

TABLE 1.16
Experimental results of Heart Disease Dataset

| Method | Ftr. | Acc | F1 |
|---|---|---|---|
| AF | 13 | 41.667 | 34.60 |
| KNFI | 4 | 56.667 | 51.53 |
| RFE | 4 | 43.333 | 36.71 |
| KNFE | −11 | 51.667 | 40.90 |

TABLE 1.17
Experimental results of Abalone Dataset

| Method | Ftr. | Acc | F1 |
|---|---|---|---|
| AF | 8 | 24.521 | 22.86 |
| KNFI | 1 | 21.650 | 20.27 |
| RFE | 1 | 17.344 | 17.14 |
| KNFE | 0 | 25.239 | 23.61 |

The KNFE and KNFI methods performed well on the Iris Dataset (Table 1.15) when selecting two of the best features from all four of the features. The KNFI method resulted in a massive fifteen percent increase in accuracy along with a considerable increase in F1 score on the heart disease dataset (Table 1.17), and KNFE also increased the accuracy on that dataset.

For the Abalone dataset, the KNFI method did not improve the performance, but the KNFE method did increase performance. The dataset contains a lower number of features and many classes. This makes the prediction of classification very tricky, and if additional knowledge is not obtained from the FS method, it may not increase the performance.

### EXAMPLE 2

The hybrid methods of embodiments of the subject invention (using KNFE and KNFI approaches) were compared with other related art methods. Tables 1.18 and 1.19 show results of the comparison on the UNSW NB15 dataset. In comparison with the related art methods, the KNFI approach produced improved results for binary and multiclass datasets. As a preprocessing step, all the instances that had “NaN” values were removed, which decreased the total number of instances. This enhanced the performance of the classifier. When the hybrid model was run on this dataset, the efficacy of the predictor increased significantly.

TABLE 1.18
Comparision of Accuracy for Binary
UNSW_NB15 with previous studies

| Study | Method | Accuracy |
|---|---|---|
| Zewairi, et al.[AZAA17] | Deep Learning | 98.99 |
| | Random Forest | 95.5 |
| Primartha and Tama [PT17] | Multilayer Perceptron | 83.50 |
| | Naive Bayes | 79.50 |
| Nour, et al.[MS17] | Linear Regression | 83.00 |
| | Expectation-Maximization | 77.20 |
| Belouch, et al.[BEI17] | Random Tree | 86.59 |
| | Naive Bayes | 80.40 |
| | RepTree | 87.80 |
| | Artificial Neural Network | 86.31 |
| | Decision Tree | 86.13 |
| Faker, et al. | Gradient Boosted Tree | 97.92 |
| | Random Forest | 98.86 |
| | Deep Neural Network | 99.19 |
| Our Work | Random Forest(AF) | 99.93 |
| | KNFI | 99.963 |
| | KNFE | 99.944 |

TABLE 1.19
Comparision of Accuracy for UNSW_NB15
MultiClass with previous studies

| Study | Method | Accuracy |
|---|---|---|
| Belouch, et al.[BEI17] | Random Tree | 76.21 |
| | Naive Bayes | 73.86 |
| | RepTree | 79.20 |
| | Artificial Neural Network | 78.14 |
| Our Work | Random Forest(AF) | 89.326 |
| | KNFI | 90.107 |
| | KNFE | 89.591 |

TABLE 1.20
Comparision of Ionosphere data with Previous Studies

| Method | # Ftr. | F1 | RC | Pr | Acc |
|---|---|---|---|---|---|
| Venkatesh et al.[VA19] | 15 | 95.09 | 94.65 | 95.70 | 95.28 |
| HGEFS [XYW18] | n.a. | n.a. | n.a. | n.a | 91.33 |
| FSFOA [GFD16] | n.a. | n.a. | n.a. | n.a | 95.12 |
| KNFI | 6 | 97.14 | 97.18 | 97.29 | 97.18 |
| KNFE | −7 | 95.74 | 95.77 | 95.76 | 95.77 |

TABLE 1.21
Comparision of Accuracy for Spambase
dataset with previous studies

| Ftr. selection method | # features | accuracy |
|---|---|---|
| GAMIFS[ETPZ09] | 3 | 83.50 |
| NMIFS[ETPZ09] | 3 | 75.8 |
| MIFS[Bat94] | 3 | 78.4 |
| MIFS-U[KC02] | 3 | 81.2 |
| OFS-MI [ETPZ09, CH05] | 3 | 78.4 |
| KNFE | 3 | 84.15 |
| KNFI | 15 | 97.82 |
| KNFE(MAX) | 54 | 98.59 |

TABLE 1.22
Comparision of Accuracy for Sonar dataset with previous studies

| Ftr. selection method | # features | accuracy |
|---|---|---|
| NMIFS[ETPZ09] | 15 | 86.73 |
| MIFS(β = 0.5)[Bat94] | 15 | 85.96 |
| MIFS-U(β = 0.5)[KC02] | 15 | 84.04 |
| HGFES[XYW18] | N.A. | 83.00 |
| FSFOA[GFD16] | N.A | 86.98 |
| KNFE | 15 | 92.85 |
| KNFI | 3 | 95.24 |
| KNFE(MAX) | 51 | 97.62 |

Table 1.20 shows results of a comparison using the Ionosphere dataset. Referring to Table 1.20, both the KNFI and KNFE methods produced much better results with greater classification accuracy than the related art methods.

Table 1.21 shows results of a comparison using the Spambase dataset, and Table 1.21 shows results of a comparison using the Sonar dataset. Classification accuracy was considered because other evaluation metrics were not provided for the related works, which calculated the rate of classification for the different number of selected features. As a comparison metric, the instances with the highest accuracy as presented in the related art method papers was used. To give comparative analysis, the accuracy using KNFE was also calculated for the same number of features as provided in the related art method papers. Referring to Table 1.21 and Table 1.22, the methods of embodiments of the subject invention outperformed the related art methods giving good results. The KNFE(MAX) represents the hybrid method of embodiments of the subject invention without any constraint on the number of required features.

In most of the datasets, KNFI performed well taking the least number of features whereas, in datasets with the least relationship among the features, the KNFE method performed very well.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

1. A system for performing feature selection in machine learning, the system comprising:
a processor; and
a machine-readable medium in operable communication with the processor and comprising instructions stored thereon that, when executed by the processor, perform the following steps:
receiving a dataset;
performing feature ranking on the dataset using a filter technique to obtain a ranking list of features; and
performing feature selection on the ranking list using a wrapper technique,
the filter technique comprising clustering data of the dataset and then using normalized mutual information (NMI) as a metric for ranking to generate the ranking list of features,
the NMI calculated as follows:
$$NMI ( Ω , S ) = \frac{MI ( Ω ; S )}{[ G ( Ω ) + G ( S ) ) ] / 2} ,$$
where
$$MI ( Ω ; S ) = {\sum }_{k} {\sum }_{j} P ( {d}_{k} ⋂ {s}_{j} ) log \frac{P ( {d}_{k} ⋂ {s}_{j} )}{P ( {d}_{k} ) P ( {s}_{j} )} , \\ G ( Ω ) = - {\sum }_{k} ( {d}_{k} ) log P ( {d}_{k} ) ,$$
and
where Ω is a set of clusters, S is a set of classes, P(dₖ)=probability of data in cluster dₖ, P(sⱼ)=probability of data in cluster sⱼ, G(S) is an entropy of the set of classes, and P(dₖ∩sⱼ)=probability of data being in a convergence of dₖ and sⱼ,
the use of the filter technique and the wrapper technique improving a runtime of the processor, and
the wrapper technique comprising performing a feature inclusion process.

2. The system according to claim 1, the filter technique comprising K-means clustering.

3. The system according to claim 1, the filter technique comprising mini-batch K-means clustering.

4. (canceled)

5. The system according to claim 1, the clustering of the data of the dataset comprising K-means clustering.

6. The system according to claim 1, the clustering of the data of the dataset comprising mini-batch K-means clustering.

7. The system according to claim 1, the wrapper technique comprising removing redundant features that have a dependency on other features.

8. (canceled)

9. The system according to claim 1, the feature inclusion process comprising performing Algorithm 1:
feature S = {f₀, f₁, f₂, . . . fₘ}, where m = total number of features, obtained from the
feature ranking phase, f₀ is the highest ranked feature and fₘ is the least ranked feature
Algorithm 1:
input: set of ranked features S = {f₀, f₁, f₂, . . . fₘ}, where m = total number of features,
obtained from the feature ranking phase, f₀ is the highest ranked feature and fₘ is the
least ranked feature
output: provides the selected set of features

| | initialization : |
|---|---|
| 1: | Lst = S[0] prev = 0, where prev represents a previous accuracy of a model |
| 2: | for k = 0 to m−1 do |
| | |
|---|---|
| 3: | x_tst = x_tst [ Lst ] |
| 4: | x_tr = x_tr [ Lst ] |
| 5: | train the model based on any classifier and store an accuracy on acc |
| 6: | if acc > prev then |
| | |
|---|---|
| 7: | if (k ≠ m − 1) then |
| | |
|---|---|
| 8: | add S[ k + 1 ] into the Lst |
| 9: | prev = acc |
| | |
|---|---|
| 10: | else |
| | |
|---|---|
| 11: | end if |
| | |
|---|---|
| 12: | else |
| | |
|---|---|
| 13: | remove S [ k ] object from the Lst |
| 14: | if (k ≠ m − 1) then |
| | |
|---|---|
| 15: | add S[ k + 1 ] to the Lst |
| | |
|---|---|
| 16: | else |
| 17: | end if |
| | |
|---|---|
| 18: | end if |
| | |
|---|---|
| 19: | end for |

10-11. (canceled)

12. A method for performing feature selection in machine learning, the method comprising:
receiving, by a processor, a dataset;
performing, by the processor, feature ranking on the dataset using a filter technique to obtain a ranking list of features; and
performing, by the processor, feature selection on the ranking list using a wrapper technique,
the filter technique comprising clustering data of the dataset and then using normalized mutual information (NMI) as a metric for ranking to generate the ranking list of features,
the NMI calculated as follows:
$$NMI ( Ω , S ) = \frac{MI ( Ω ; S )}{[ G ( Ω ) + G ( S ) ) ] / 2} ,$$
where
$$MI ( Ω ; S ) = {\sum }_{k} {\sum }_{j} P ( {d}_{k} ⋂ {s}_{j} ) log \frac{P ( {d}_{k} ⋂ {s}_{j} )}{P ( {d}_{k} ) P ( {s}_{j} )} , \\ G ( Ω ) = - {\sum }_{k} ( {d}_{k} ) log P ( {d}_{k} ) ,$$
and
where Ω is a set of clusters, S is a set of classes, P(dₖ)=probability of data in cluster dₖ, P(sⱼ)=probability of data in cluster sⱼ, G(S) is an entropy of the set of classes, and P(dₖ∩sⱼ)=probability of data being in a convergence of dₖ and sⱼ,
the use of the filter technique and the wrapper technique improving a runtime of the processor, and
the wrapper technique comprising performing a feature inclusion process.

13. The method according to claim 12, the filter technique comprising mini-batch K-means clustering.

14. (canceled)

15. The method according to claim 12, the wrapper technique comprising removing redundant features that have a dependency on other features.

16. (canceled)

17. The method according to claim 12, the feature inclusion process comprising performing Algorithm 1:
Algorithm 1:
input: set of ranked features S = {f₀, f₁, f₂, . . . fₘ}, where m = total number of features,
obtained from the feature ranking phase, f₀ is the highest ranked feature and fₘ is the
least ranked feature
output: provides the selected set of features

| | initialization : |
|---|---|
| 1: | Lst = S[0] prev = 0, where prev represents a previous accuracy of a model |
| 2: | for k = 0 to m−1 do |
| | |
|---|---|
| 3: | x_tst = x_tst [ Lst ] |
| 4: | x_tr = x_tr [ Lst ] |
| 5: | train the model based on any classifier and store an accuracy on acc |
| 6: | if acc > prev then |
| | |
|---|---|
| 7: | if (k ≠ m − 1) then |
| | |
|---|---|
| 8: | add S[ k + 1 ] into the Lst |
| 9: | prev = acc |
| | |
|---|---|
| 10: | else |
| | |
|---|---|
| 11: | end if |
| | |
|---|---|
| 12: | else |
| | |
|---|---|
| 13: | remove S [ k ] object from the Lst |
| 14: | if (k ≠ m − 1) then |
| | |
|---|---|
| 15: | add S[ k + 1 ] to the Lst |
| | |
|---|---|
| 16: | else |
| 17: | end if |
| | |
|---|---|
| 18: | end if |
| | |
|---|---|
| 19: | end for. |

18-19. (canceled)

20. A system for performing feature selection in machine learning, the system comprising:
a processor; and
a machine-readable medium in operable communication with the processor and comprising instructions stored thereon that, when executed by the processor, perform the following steps:
receiving a dataset;
performing feature ranking on the dataset using a filter technique to obtain a ranking list of features; and
performing feature selection on the ranking list using a wrapper technique,
the filter technique comprising clustering data of the dataset and then using normalized mutual information (NMI) as a metric for ranking to generate the ranking list of features,
the NMI calculated as follows:
$$NMI ( Ω , S ) = \frac{MI ( Ω ; S )}{[ G ( Ω ) + G ( S ) ) ] / 2} ,$$
where
$$MI ( Ω ; S ) = {\sum }_{k} {\sum }_{j} P ( {d}_{k} ⋂ {s}_{j} ) log \frac{P ( {d}_{k} ⋂ {s}_{j} )}{P ( {d}_{k} ) P ( {s}_{j} )} , \\ G ( Ω ) = - {\sum }_{k} ( {d}_{k} ) log P ( {d}_{k} ) ,$$
where Ω is a set of clusters, S is a set of classes, P(dₖ)=probability of data in cluster dₖ, P(sⱼ)=probability of data in cluster sⱼ, G(S) is an entropy of the set of classes, and P(dₖ∩sⱼ)=probability of data being in a convergence of dₖ and sⱼ,
the clustering of the data of the dataset comprising mini-batch K-means clustering,
the wrapper technique comprising removing redundant features that have a dependency on other features,
the wrapper technique comprising performing a feature inclusion process,
the use of the filter technique and the wrapper technique improving a runtime of the processor, and
the feature inclusion process comprising performing Algorithm 1:
Algorithm 1:
input: set of ranked features S = {f₀, f₁, f₂, . . . fₘ}, where m = total number of features,
obtained from the feature ranking phase, f₀ is the highest ranked feature and fₘ is the
least ranked feature
output: provides the selected set of features

| | initialization : |
|---|---|
| 1: | Lst = S[0] prev = 0, where prev represents a previous accuracy of a model |
| 2: | for k = 0 to m−1 do |
| | |
|---|---|
| 3: | x_tst = x_tst [ Lst ] |
| 4: | x_tr = x_tr [ Lst ] |
| 5: | train the model based on any classifier and store an accuracy on acc |
| 6: | if acc > prev then |
| | |
|---|---|
| 7: | if (k ≠ m − 1) then |
| | |
|---|---|
| 8: | add S[ k + 1 ] into the Lst |
| 9: | prev = acc |
| | |
|---|---|
| 10: | else |
| | |
|---|---|
| 11: | end if |
| | |
|---|---|
| 12: | else |
| | |
|---|---|
| 13: | remove S [ k ] object from the Lst |
| 14: | if (k ≠ m − 1) then |
| | |
|---|---|
| 15: | add S[ k + 1 ] to the Lst |
| | |
|---|---|
| 16: | else |
| 17: | end if |
| | |
|---|---|
| 18: | end if |
| | |
|---|---|
| 19: | end for. |
